(19) United States
(12) Patent Application Publication
(10) Pub. No.: US 2025/0390390 A1
(43) Pub. Date: Dec. 25, 2025

(54) TECHNIQUES TO MANAGE PARITY INFORMATION FOR DATA TRANSFER OPERATIONS

(71) Applicant: Micron Technology, Inc., Boise, ID (US)

(72) Inventors: Jameer Mulani, Bangalore (IN); Jonathan S. Parry, Boise, ID (US); Luis Iam, San Jose, CA (US); Zhengang Chen, San Jose, CA (US)

(21) Appl. No.: 19/239,418

(22) Filed: Jun. 16, 2025

Related U.S. Application Data
(60) Provisional application No. 63/663,592, filed on Jun. 24, 2024.

(51) Int. Cl. G06F 11/10; G06F 13/16

(52) U.S. Cl. CPC G06F 11/1076; G06F 11/1048; G06F 13/1668

(57) ABSTRACT

Methods, systems, and devices for techniques to manage parity information for data transfer operations are described. A memory system may produce additional parity information for data to be stored in a set of multi-level memory cells. The memory system may receive a command to store data and may determine whether a destination physical address for the data includes a weak word line using a mapping. The memory system may generate parity information for the data using a mapping between a first set of single-level memory cells and a second set of multi-level memory cells configured to store multiple bits of data. The memory system may store the data and the parity information to the first set of single-level memory cells and may transfer the data and the parity information from the first set of single-level memory cells to the second set of multi-level memory cells.

### CROSS REFERENCE

The present Application for Patent claims priority to U.S. Patent Application No. 63/663,592 by Mulani et al., entitled “TECHNIQUES TO MANAGE PARITY INFORMATION FOR DATA TRANSFER OPERATIONS,” filed Jun. 24, 2024, which is assigned to the assignee hereof, and which is expressly incorporated by reference in its entirety herein.

### TECHNICAL FIELD

The following relates to one or more systems for memory, including techniques to manage parity information for data transfer operations.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports techniques to manage parity information for data transfer operations in accordance with examples as disclosed herein.

FIG. 2 shows an example of a memory system that supports techniques to manage parity information for data transfer operations in accordance with examples as disclosed herein.

FIG. 3 shows a block diagram of a memory system that supports techniques to manage parity information for data transfer operations in accordance with examples as disclosed herein.

FIG. 4 shows a flowchart illustrating a method or methods that support techniques to manage parity information for data transfer operations in accordance with examples as disclosed herein.

### DETAILED DESCRIPTION

In some memory systems, a memory device may perform an operation to copy (e.g., “fold”) multiple bits within single-level cells (SLCs) to a higher-level cell such as a quad-level cell (QLC). Information in QLCs may experience higher error rates than information in SLCs (e.g., contributing to weak word lines). Weaker word lines may have a bigger impact for QLC memory cells due to a higher likelihood of errors in QLC cells. In some cases, blocks with weak word lines may be retired. However, such techniques may result in the memory device wearing out relatively quickly. Thus, techniques to use weak word lines to store data in QLC memory cells may extend a life of a memory system.

Techniques described herein may support a memory system that performs one or more operations to produce additional parity information for data to be stored in a set of one or more QLCs. The memory system may receive a command to store data and in response, may determine whether a destination physical address for the data includes a weak word line using a mapping. In some cases, the memory system may initially store the data in SLC memory cells and then fold the data into memory cells with a higher density storage (e.g., QLCs). During an evaluation of whether a destination physical address includes a weak word line, the memory system may evaluate the physical addresses of the QLC memory cells that will ultimately store the information. The memory system may generate parity information for the data using a mapping between a first set of single-level memory cells and a second set of multi-level memory cells (e.g., QLC). Each memory cell of the second set of multi-level memory cells may be configured to store two or more bits of data. The memory system may store the data and the parity information to the first set of single-level memory cells (e.g., SLCs). In some cases, the memory system may transfer, as part of a memory management operation, the data and the parity information from the first set of single-level memory cells to the second set of multi-level memory cells (e.g., QLCs). Thus, the memory system may support transferring data, with corresponding parity information, from lower-level memory cells to higher-level memory cells.

In addition to applicability in memory systems as described herein, techniques for managing parity information for data transfer operations may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing errors in QLC folding performance, which may decrease processing or latency times, improve response times, or otherwise improve user experience, among other benefits.

In addition to applicability in memory systems as described herein, techniques for managing parity information for data transfer operations may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by reducing write amplification at a device, which may extend the life of electronic devices, thereby reducing electronic waste, among other benefits.

Features of the disclosure are illustrated and described in the context of systems, devices, and circuits. Features of the disclosure are further illustrated and described in the context of memory systems and flowcharts.

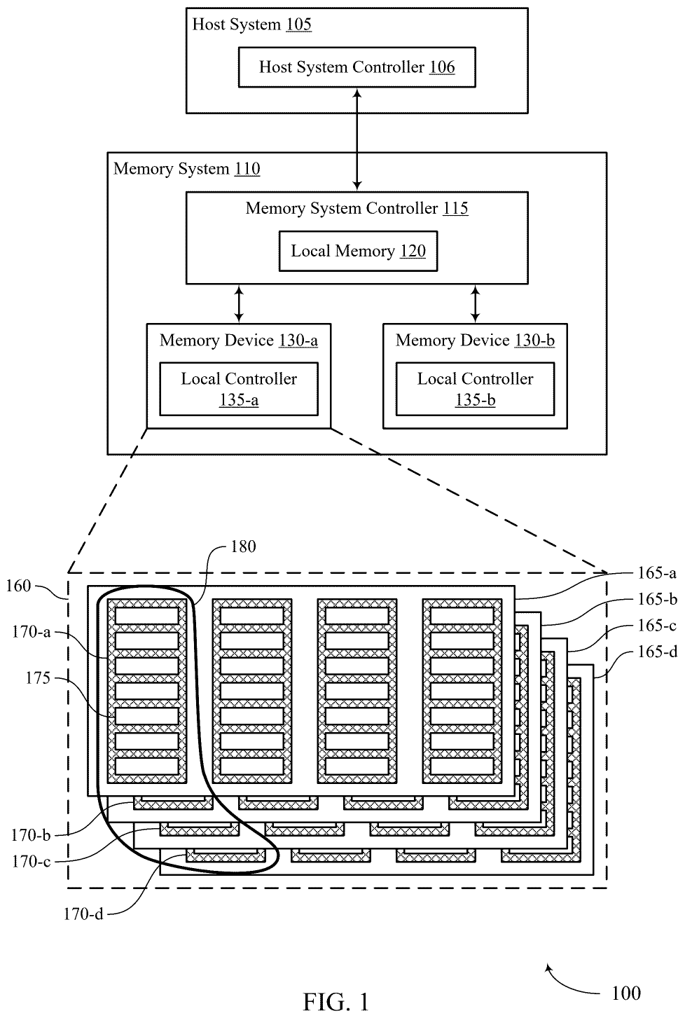

FIG. 1 shows an example of a system 100 that supports techniques to manage parity information for data transfer operations in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some systems, a memory device may include memory cells such as SLCs and MLCs. MLCs may refer to higher level memory cells such as TLCs, QLCs, or similar higher level memory cells. An MLC may store multiple bits per cell (e.g., having multiple levels or states within each cell). An SLC may store one bit per cell, which may take a single value (e.g., a value corresponding to ‘1’ or ‘0’). Some systems may have reduced memory utilization efficiency by using QLCs due to various factors. For example, a system may experience reduced random write bandwidth (RWB) due to QLC use (e.g., gradual reduction of RWB through each generation of devices). The system may use spare bytes in memory to maintain a relatively high RWB. Such an overhead may reduce an effective gigabyte per wafer value (e.g., associated with QLCs). The system may set spare bytes based on memory cells with relatively low values (e.g., setting spare bytes for memory cells associated with a relatively high stress, a relatively poor die, relatively poor word lines, and so on). Some pages within dies of the system may have excess error correction code (ECC) information due to these issues.

A memory system may apply dynamic ECC techniques for error detection and correction. For example, the memory system may include ECC bits (e.g., XOR bits) to account for relatively “weak” word lines (e.g., word lines associated with relatively high error rates and associated with MLCs such as QLCs). The memory system may use an amount of spare area (e.g., a quantity of spare bytes) based on (e.g., using) a median (e.g., an average or normal word line) of a set of word lines of the memory system. The memory system may include additional parity bits to protect weak word lines (e.g., to detect or correct potential errors in memory due to the weak word lines). This may have a relatively minor impact on performance for the memory system and may increase system complexity (including firmware complexity). As described herein, a weak word line may refer to a word line including memory cells that correspond to a relatively high bit error rate (as compared with other word lines). For example, weak word lines may include QLCs, or cells that may store four bits per cell.

As described herein, a memory system may apply dynamic ECC techniques. For example, the memory system may include an ECC stripe (e.g., an XOR stripe) across page types within a single die 160 and within a single word line. Such dynamic ECC techniques may be applicable to QLC “weak” word lines. In some cases, QLC “weak” word lines may make up a portion of a total quantity of word lines (e.g., 20% of all word lines). If the memory system applies the dynamic ECC techniques, the memory system may use a portion of each word line for dynamic ECC parity bits (e.g., 1/16 of a total quantity of bits for each word line). In some cases, dynamic ECC techniques may provide extra protection for memory cells (e.g., a particular voltage of extra protection). In some cases, a memory device (e.g., a managed NAND (mNAND) device) may use an internal copyback procedure to apply SLC to MLC folding (including SLC to QLC folding). As described herein, a copyback procedure (e.g., an internal copyback procedure) may refer to writing (e.g., copying or storing) information from one set of cells within a memory device to another set of cells within the memory device. For example, a memory system may execute a copyback procedure to copy a set of data from a set of SLCs to one or more MLCs (e.g., without sending the set of data to a controller). A copyback command received at a memory system (or a memory device) may cause the memory system to execute a copyback procedure. In some cases, the memory device may support TLC to QLC folding under some conditions (e.g., while avoiding high temperature or X-temp factors).

In some memory systems, a memory controller (e.g., an mNAND controller) may generate parity information (e.g., dynamic XOR parity bits). For example, the memory controller may receive a set of input data bits from a NAND. In some cases, one or more memories (e.g., a NAND) may transmit the set of input data bits from a set of SLCs (e.g., the input data bits may correspond with source SLCs). The memory controller may decode the set of input data bits using a decoder (e.g., a low density parity check (LDPC) decoder). Then, the memory controller may store the decoded data bits in a buffer (e.g., a RAM buffer) of the memory controller. The memory controller may thus retrieve (e.g., read) the decoded data bits from the buffer and may perform an encoding procedure the decoded data bits using an encoder (e.g., an LDPC encoder). If the memory controller determines that a destination for the data bits includes a set of QLCs (or in some cases, other MLCs), the memory controller may generate, in conjunction with the encoding procedure, a set of parity bits (e.g., dynamic XOR parity bits) associated with the data bits using a dynamic ECC engine (e.g., XOR engine). The memory controller may then transmit the encoded data bits, with corresponding parity bits, to the one or more memories (e.g., the NAND), where the NAND may store the encoded data bits and the corresponding parity bits in a set of MLCs, such as QLCs. Thus, a memory may transfer or copy a set of data from a set of SLCs to a set of QLCs via an associated memory controller. Such a method may have a performance impact (e.g., a major performance impact) on devices which support copyback operations (e.g., operations that copy data from a source to a destination internal to a memory device such as a NAND device).

Some memory systems may include, in a memory region of a memory device, a dynamic ECC engine (e.g., XOR engine), which may increase die size, power consumption, or similar issues. A memory system that includes the dynamic ECC engine in a controller region of a memory device may result in additional overhead of transferring data from a memory and a controller and back to the memory. Thus, such methods may cause additional overhead of data transfer (e.g., open NAND Flash Interface (ONFI) transfer) and related performance drops for folding from one or more SLCs to one or more QLCs. A memory system that does not support or use copyback operations may experience decreased folding performance for devices that have relatively low ONFI frequency or performance. Such issues may be worsened due to an application specific integrated circuit (ASIC) of a memory system, due to latency of dynamic XOR variants, due to error handling flow, due to hold up capacitors or retention RAM, or similar factors associated with memory systems. Further, a memory system may use relatively greater amounts of memory while executing such operations, since a buffer of the memory system may maintain data until the buffer is full and until parity is sent to a NAND latch of the memory system.

A memory system 110 may perform one or more operations to produce additional parity information for data that is stored in one or more QLCs. The memory system 110 may receive a command to store data. The memory system 110 may determine whether a destination physical address for the data includes a weak word line using a mapping. In some cases, the memory system 110 may initially store the data in SLC memory cells and then fold the data into memory cells with a higher density storage (e.g., QLCs). In an evaluation to determine whether a destination physical address includes a weak word line, the memory system 110 may evaluate the physical addresses of the QLC memory cells that will ultimately store the information. The memory system 110 may generate parity information for the data using a mapping between a first set of single-level memory cells and a second set of multi-level memory cells (e.g., QLC). Each memory cell of the second set of multi-level memory cells may be configured to store two or more bits of data. The memory system 110 may store the data and the parity information to the first set of single-level memory cells. In some cases, the memory system 110 may transfer, as part of a memory management operation, the data and the parity information from the first set of single-level memory cells to the second set of multi-level memory cells. Thus, the memory system 110 may support transferring data, with corresponding parity information, from lower-level memory cells to higher-level memory cells.

The system 100 may include any quantity of non-transitory computer readable media that support techniques to manage parity information for data transfer operations. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

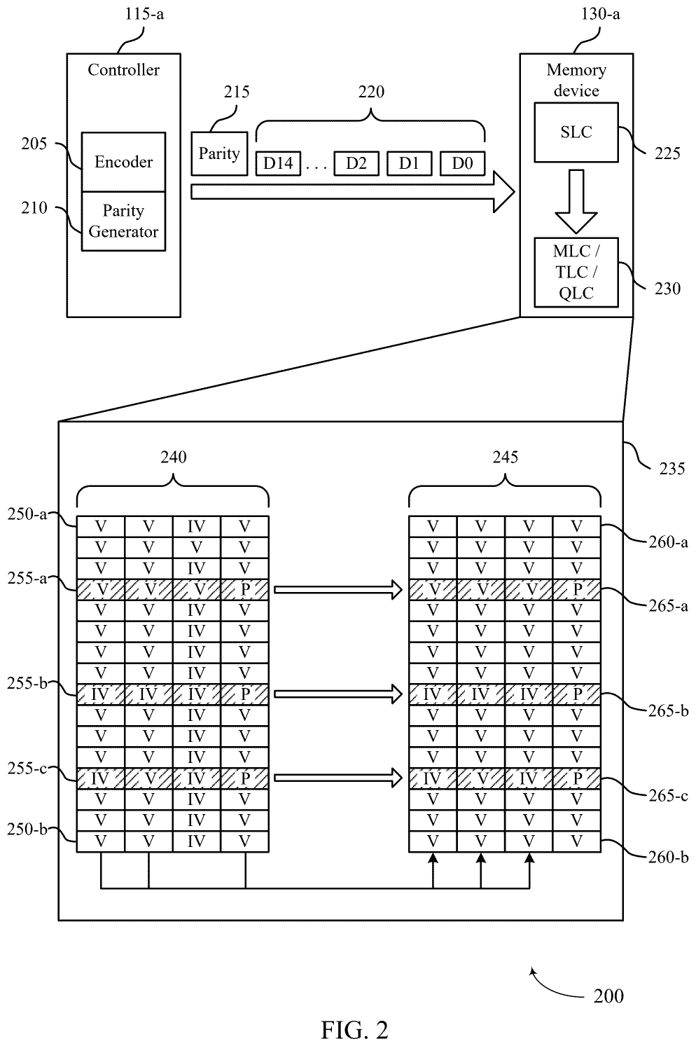

FIG. 2 shows an example of a memory system 200 that supports techniques to manage parity information for data transfer operations in accordance with examples as disclosed herein. In some cases, the memory system 200 may implement or be implemented by aspects of the system 100. For example, the memory system 200 may be an example of a memory system 110 and may include a controller 115-a (which may be an example of a memory system controller 115 or a local controller 135) and a memory device 130-a (which may be an example of a memory device 130-a or a memory device 130-b). In some cases, the memory device 130-a may be an example of a NAND memory device. In some examples, the controller 115-a may refer to multiple controllers, and the memory device 130-a may refer to multiple memory devices or multiple memories. In the following description, although some processes or operations are described to be performed by a component of the memory system 110 (e.g., a controller 115-a or a memory device 130-a), it may be interpreted that the memory system 110 may perform these processes or operations.

In some implementations, the controller 115-a may include an encoder 205 and a parity generator 210. In some cases, the controller 115-a may obtain a set of data bits 220. For example, the controller 115-a may receive the set of data bits 220 from the memory device 130-a (e.g., from an origin set of SLCs). In some examples, the controller 115-a may receive the set of data bits 220 from another controller, from a host system 105, or both. In some cases, the controller 115-a may detect a command to store data to the memory system 200 (e.g., a command received at the memory system 110).

In some implementations, the controller 115-a may generate parity information 215 using the parity generator 210 and using the set of data bits 220. In some cases, the controller may generate parity information for the data based on a mapping between a set of SLCs (e.g., single-level memory cells) and a set of multiple level memory cells (e.g., MLCs, TLCs, QLCs, penta-level cells, etc.).

Weak word lines may refer to word lines that are more likely to experience one or more errors than other word lines. Some types of memory cells (such as QLC) are also associated with higher error rates. As such, some memory systems may experience a higher likelihood of having weak word lines in QLC word lines than in SLC word lines. Additionally, in some memory systems, data received from the host may initially be written in SLC blocks to increase the speed of performing host write commands. Later, the data that is initially stored in SLC blocks may be folded (e.g., transferred) to other multiple level cells (e.g., MLC, TLC, QLC) as part of a background operation. This increases the density of the storage, while also maintaining the speed of performing host write commands. The mapping between the SLCs and multiple level memory cells enables the memory system to generate parity information for weak QLC word lines when writing the initial data into the SLC word lines.

The controller 115-a may determine to generate the parity information 215 in response to determining that a destination corresponding to the data bits 220 includes or is associated with one or more memory cells associated with weak word lines (e.g., corresponding to QLCs weak word lines). In some cases, the parity information 215 may be used (e.g., by a memory device) to detect and correct errors in the set of data bits 220 (e.g., dynamic XOR parity information). After generating the parity information 215, the controller 115-a may encode the parity information 215, the data bits 220, or both, using the encoder 205. Then, the controller 115-a may output the parity information 215, the data bits 220, or both, to the memory device 130-a. The memory device 130-a may store the data bits 220 and the parity information 215 in the SLC blocks. Later, the memory device 130-a may fold (e.g., transfer) the data bits 220 and the parity information 215 into multiple level blocks (e.g., MLC, TLC, QLC).

In some cases, the memory device 130-a may receive a second command (e.g., a copyback command) from the controller 115-a to store information to one or more sets of memory cells. The memory device 130-a may receive the parity information 215, the data bits 220, or both, and may store this information (e.g., based on the second command) in one or more memory cells of the memory device 130-a. For example, the memory device 130-a may store the parity information 215 and the data bits 220 in one or more SLCs 225. Additionally or alternatively, the memory device 130-a may store the parity information 215 and the data bits 220 in one or more multiple-level cells 230 (e.g., MLCs, TLCs, QLCs, or other memory cells). In any case, the memory device 130-a may store the parity information 215 and the data bits 220 in a set of memory cells that are associated with weak word lines (e.g., SLCs that are mapped to cells associated with weak word lines, or QLCs that contribute to weak word lines). In some examples, a set of writes (e.g., host writes) received at the memory system 110 may be directed to the one or more SLCs 225 (e.g., the memory system 110 may refrain from receiving write commands directed to the one or more multiple-level cells 230). In other words, each write command received at the memory system 110 may include a target destination including SLCs.

In some implementations, the memory device 130-a may perform a procedure 235. In some examples, processes or steps within the procedure 235 may be implemented in instructions, firmware, or both, stored on a memory system 110 (e.g., the memory device 130-a or another memory device). Aspects of the procedure 235 may be implemented by one or more controllers, among other components. Additionally or alternatively, aspects of the procedure 235 may be implemented as instructions stored in one or more memories (e.g., firmware stored in one or more memories coupled with a memory device 130-a). For example, the instructions, when executed by one or more controllers (e.g., a local controller 135-a on the memory device 130-a), may cause the one or more controllers (or a device or a system) to perform the operations of the procedure 235.

The procedure 235 may include one or more memory transfers (e.g., reading and storing data within the memory device 130-a). For example, the memory device 130-a may transfer a set of information located in source cells 240 to destination cells 245. The source cells 240 may include memory cells such as SLCs (e.g., lower-level memory cells). In some examples, the source cells may include one or more word lines 250 and may include one or more pseudo-weak word lines 255. As described herein, pseudo-weak word lines may be referred to as “proxy” weak word lines. For example, SLC word lines used initial writing may be mapped to QLC word lines that will ultimately store the data. Some QLC word lines may be weak word lines. The SLC word lines that correspond to weak QLC word lines in the mapping may be referred to as the “proxy” weak word lines. Each pseudo-weak word line (e.g., “proxy” weak SLC word lines) of a set of pseudo-weak word lines may be mapped to a respective weak word line of a set of weak word lines (e.g., QLC weak word lines). In some cases, each word line 250 (e.g., a word line 250-a or a word line 250-b) may include a combination of one or more valid bits (e.g., represented by ‘V’ boxes) and one or more invalid bits (e.g., represented by ‘IV’ boxes). Each pseudo-weak word line may include one or more valid bits, one or more invalid bits, one or more parity bits (e.g., represented by ‘P’ boxes), or a combination thereof.

The destination cells 245 may include memory cells such as QLCs (or other multiple-level cells). The destination cells 245 may include word lines 260 and weak word lines 265 (e.g., made up of QLCs). The weak word lines 265 may be relatively constant across the memory system 110 (e.g., across blocks 170, dies 160, planes 165, and so on). For example, the memory system 110 may include (e.g., at the controller 115-a) a mapping between SLCs 225 and multiple-level cells 230. In some cases, the memory system 110 may generate the mapping between the SLCs 225 and the multiple-level cells 230 based at least in part on determining that the multiple-level cells 230 fail to satisfy a performance threshold (e.g., if some of the multiple-level cells 230 have a bit error rate that exceeds a threshold value or an information retention rate that does not exceed a threshold value).

In some implementations, the procedure 235 may include a folding procedure (e.g., transferring information from SLCs to MLCs, TLCs, QLCs, or other types of memory cells). For example, the procedure 235 may include writing (e.g., storing or copying) information from the source cells 240 to the destination cells 245. In some cases, the memory device 130-a may copy information (e.g., via a copyback procedure) in one or more word lines 250 to one or more word lines 260 (e.g., “normal” word lines). For example, the memory device 130-a may determine to copy contents from the word line 250-a to the word line 260-a, and may copy valid information from the word line 250-a to the word line 260-a. In other words, the memory device 130-a may read information in a set of SLCs corresponding to valid bits and may write the information to a set of QLCs and may refrain from copying invalid bits from the SLCs to the QLCs. Similarly, the memory device 130-a may copy valid information from the word line 250-b to the word line 260-b. During a folding procedure (e.g., the procedure 235), the memory device 130-a may read source data from one or more source SLCs (e.g., source cells 240) to one or more latches (e.g., NAND latches). Using a copyback mechanism, the memory device 130-a may program one or more destination cells 245 (e.g., from the one or more latches). In some cases, while scanning a block 170 (e.g., on a die 160 within the memory device 130-a), the memory device 130-a may copy data from the source cells 240 to the destination cells 245 by applying validity skipping (e.g., skipping cells that include only invalid bits).

Similarly, the memory device 130-a may copy parity information bits (e.g., dynamic XOR parity) and data bits (e.g., user data) from the source cells 240 to the destination cells 245. The memory device 130-a may copy information from the one or more pseudo-weak word lines 255 to the one or more weak word lines 265 (e.g., copying the parity information bits and the data bits of a pseudo-weak word line in the source cells 240 to a weak word line in the destination cells 245). In some cases, a word line may include data with parity information associated with a first type of error correction (e.g., dynamic XOR) and the data may include second parity information associated with a second type of error correction (e.g., ECC).

The memory device 130-a may copy information from the pseudo-weak word lines 255 (e.g., “dummy” weak word lines) to the weak word lines 265 according to three cases. For example, a pseudo-weak word line 255-a may include a set of valid bits (e.g., ‘V’) and parity information. Because all data bits of the pseudo-weak word line 255-a are valid, the memory device 130-a may copy all the data bits from the pseudo-weak word line 255-a, along with the parity information, to a weak word line 265-a. A pseudo-weak word line 255-b may include a set of invalid bits (e.g., ‘IV’) and parity information. In some cases, the memory device 130-a may copy all the data bits from the pseudo-weak word line 255-b, along with the parity information, to a weak word line 265-b (e.g., including all invalid bits). Additionally or alternatively, the memory device 130-a may refrain from copying the information from the pseudo-weak word line 255-b to any destination cell 245. A pseudo-weak word line 255-c may include a combination of valid bits and invalid bits. Since the pseudo-weak word line 255-c includes at least one valid bit, the memory device 130-a may copy all the data bits from the pseudo-weak word line 255-c, along with the parity information, to a weak word line 265-c (e.g., including all invalid bits). In some cases, for a pseudo-weak word line 255-c (e.g., including valid and invalid bits), a controller 115-a may generate parity information using all data bits (e.g., including valid and invalid bits).

During a folding procedure (e.g., the procedure 235), if a destination includes a weak word line (e.g., a QLC weak word line), the memory device 130-a may copy a valid or partially valid pseudo-weak word line 255 to a corresponding weak word line 265 and may maintain a record of (e.g., keep track of) an identifier (e.g., a number) of a next pseudo-weak word line 255 to be copied. Such a folding procedure may have a relatively small write amplification impact. For example, although invalid data bits may be copied for weak word lines, the invalid data bits may be cleared during a next folding procedure (e.g., QLC to QLC folding). That is, the memory device 130-a may copy data corresponding to pseudo-weak word lines 255 if a destination word line is a weak word line 265. The memory device 130-a may repeat the procedure 235 for multiple occurrences (e.g., both passes) of QLC programming.

In some cases, the procedure 235 may be applied for TLC to QLC folding (e.g., the source cells 240 may include TLCs) by mapping TLCs to QLCs (e.g., in limited temperature conditions to improve reliability of source data). Similarly, the procedure 235 may be applied to weak word lines with an additional or alternative parity scheme such as dynamic ECC parity.

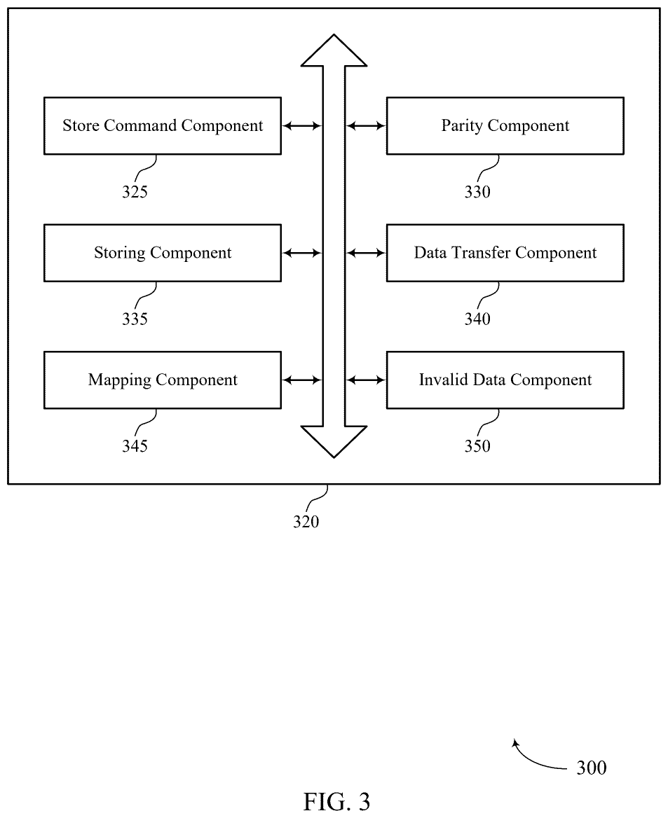

FIG. 3 shows a block diagram 300 of a memory system 320 that supports techniques to manage parity information for data transfer operations in accordance with examples as disclosed herein. The memory system 320 may be an example of aspects of a memory system as described with reference to FIGS. 1 through 2. The memory system 320, or various components thereof, may be an example of means for performing various aspects of techniques to manage parity information for data transfer operations as described herein. For example, the memory system 320 may include a store command component 325, a parity component 330, a storing component 335, a data transfer component 340, a mapping component 345, an invalid data component 350, or any combination thereof. Each of these components, or components of subcomponents thereof (e.g., one or more processors, one or more memories), may communicate, directly or indirectly, with one another (e.g., via one or more buses).

The store command component 325 may be configured as or otherwise support a means for receiving a command to store data to a memory system. The parity component 330 may be configured as or otherwise support a means for generating parity information for the data based at least in part on a mapping between a first set of single-level memory cells and a second set of multi-level memory cells, each memory cell of the second set of multi-level memory cells configured to store two or more bits of data. The storing component 335 may be configured as or otherwise support a means for storing the data and the parity information to the first set of single-level memory cells. The data transfer component 340 may be configured as or otherwise support a means for transferring, as part of a memory management operation, the data and the parity information from the first set of single-level memory cells to the second set of multi-level memory cells.

In some examples, to support transferring the data and the parity information, the data transfer component 340 may be configured as or otherwise support a means for issuing a second command from a controller of the memory system to one or more memory devices of the memory system. In some examples, to support transferring the data and the parity information, the data transfer component 340 may be configured as or otherwise support a means for transferring the data and the parity information from the first set of single-level memory cells to one or more data latches of the one or more memory devices. In some examples, to support transferring the data and the parity information, the data transfer component 340 may be configured as or otherwise support a means for transferring the data and the parity information from the one or more data latches to the second set of multi-level memory cells.

In some examples, the second command includes a copyback command.

In some examples, the mapping component 345 may be configured as or otherwise support a means for generating the mapping between the first set of single-level memory cells and the second set of multi-level memory cells based at least in part on determining that the second set of multi-level memory cells fails to satisfy a performance threshold.

In some examples, the parity information is associated with a first type of error correction and the data includes second parity information associated with a second type of error correction different than the first type.

In some examples, the store command component 325 may be configured as or otherwise support a means for receiving a second command to store second data to the memory system. In some examples, the parity component 330 may be configured as or otherwise support a means for refraining from generating second parity information for the second data based at least in part on a second mapping between a third set of single-level memory cells and a fourth set of multi-level memory cells, each memory cell of the fourth set of multi-level memory cells configured to store two or more bits of data. In some examples, the storing component 335 may be configured as or otherwise support a means for storing the second data to the third set of single-level memory cells. In some examples, the data transfer component 340 may be configured as or otherwise support a means for transferring, as part of a second memory management operation, the second data from the third set of single-level memory cells to the fourth set of multi-level memory cells.

In some examples, the mapping component 345 may be configured as or otherwise support a means for generating the second mapping between the third set of single-level memory cells and the fourth set of multi-level memory cells based at least in part on determining that the fourth set of multi-level memory cells satisfies a performance threshold.

In some examples, to support transferring the data and the parity information, the invalid data component 350 may be configured as or otherwise support a means for determining that at least a portion of the data includes invalid data. In some examples, to support transferring the data and the parity information, the storing component 335 may be configured as or otherwise support a means for storing the invalid data to the second set of multi-level memory cells based at least in part on determining that at least the portion of the data includes invalid data.

In some examples, the first set of single-level memory cells includes an SLC word line and the second set of multi-level memory cells includes a QLC word line.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

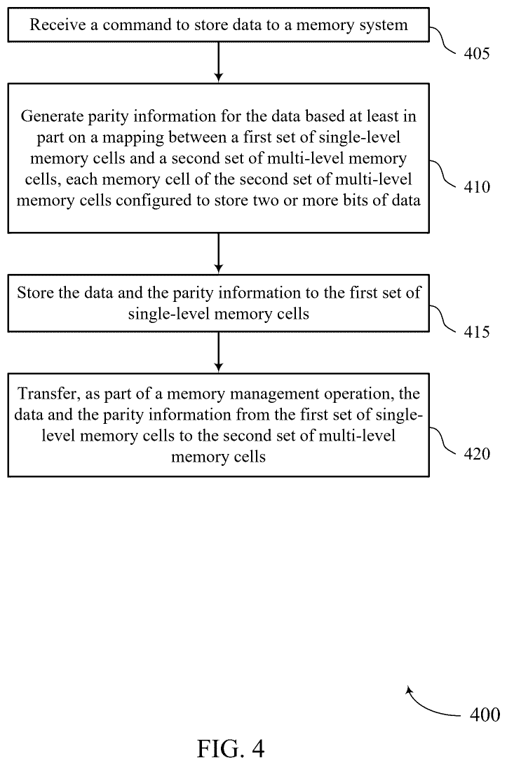

FIG. 4 shows a flowchart illustrating a process 400 that supports techniques to manage parity information for data transfer operations in accordance with examples as disclosed herein. The operations of process 400 may be implemented by a memory system or its components as described herein. For example, the operations of process 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the process may include receiving a command to store data to a memory system. In some examples, aspects of the operations of 405 may be performed by a store command component 325 as described with reference to FIG. 3.

At 410, the process may include generating parity information for the data based at least in part on a mapping between a first set of single-level memory cells and a second set of multi-level memory cells, each memory cell of the second set of multi-level memory cells configured to store two or more bits of data. In some examples, aspects of the operations of 410 may be performed by a parity component 330 as described with reference to FIG. 3.

At 415, the process may include storing the data and the parity information to the first set of single-level memory cells. In some examples, aspects of the operations of 415 may be performed by a storing component 335 as described with reference to FIG. 3.

At 420, the process may include transferring, as part of a memory management operation, the data and the parity information from the first set of single-level memory cells to the second set of multi-level memory cells. In some examples, aspects of the operations of 420 may be performed by a data transfer component 340 as described with reference to FIG. 3.

In some examples, an apparatus as described herein may perform a process or processes, such as the process 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a command to store data to a memory system; generating parity information for the data based at least in part on a mapping between a first set of single-level memory cells and a second set of multi-level memory cells, each memory cell of the second set of multi-level memory cells configured to store two or more bits of data; storing the data and the parity information to the first set of single-level memory cells; and transferring, as part of a memory management operation, the data and the parity information from the first set of single-level memory cells to the second set of multi-level memory cells.

Aspect 2: The method, apparatus, or non-transitory computer-readable medium of aspect 1, where transferring the data and the parity information includes operations, features, circuitry, logic, means, or instructions, or any combination thereof for issuing a second command from a controller of the memory system to one or more memory devices of the memory system; transferring the data and the parity information from the first set of single-level memory cells to one or more data latches of the one or more memory devices; and transferring the data and the parity information from the one or more data latches to the second set of multi-level memory cells.

Aspect 3: The method, apparatus, or non-transitory computer-readable medium of aspect 2, where the second command includes a copyback command.

Aspect 4: The method, apparatus, or non-transitory computer-readable medium of any of aspects 1 through 3, further including operations, features, circuitry, logic, means, or instructions, or any combination thereof for generating the mapping between the first set of single-level memory cells and the second set of multi-level memory cells based at least in part on determining that the second set of multi-level memory cells fails to satisfy a performance threshold.

Aspect 5: The method, apparatus, or non-transitory computer-readable medium of any of aspects 1 through 4, where the parity information is associated with a first type of error correction and the data includes second parity information associated with a second type of error correction different than the first type.

Aspect 6: The method, apparatus, or non-transitory computer-readable medium of any of aspects 1 through 5, further including operations, features, circuitry, logic, means, or instructions, or any combination thereof for receiving a second command to store second data to the memory system; refraining from generating second parity information for the second data based at least in part on a second mapping between a third set of single-level memory cells and a fourth set of multi-level memory cells, each memory cell of the fourth set of multi-level memory cells configured to store two or more bits of data; storing the second data to the third set of single-level memory cells; and transferring, as part of a second memory management operation, the second data from the third set of single-level memory cells to the fourth set of multi-level memory cells.

Aspect 7: The method, apparatus, or non-transitory computer-readable medium of aspect 6, further including operations, features, circuitry, logic, means, or instructions, or any combination thereof for generating the second mapping between the third set of single-level memory cells and the fourth set of multi-level memory cells based at least in part on determining that the fourth set of multi-level memory cells satisfies a performance threshold.

Aspect 8: The method, apparatus, or non-transitory computer-readable medium of any of aspects 1 through 7, where transferring the data and the parity information includes operations, features, circuitry, logic, means, or instructions, or any combination thereof for determining that at least a portion of the data includes invalid data and storing the invalid data to the second set of multi-level memory cells based at least in part on determining that at least the portion of the data includes invalid data.

Aspect 9: The method, apparatus, or non-transitory computer-readable medium of any of aspects 1 through 8, where the first set of single-level memory cells includes a single-level cell (SLC) word line and the second set of multi-level memory cells includes a quad-level cell (QLC) word line.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a command to store data to the memory system;
generate parity information for the data based at least in part on a mapping between a first set of single-level memory cells and a second set of multi-level memory cells, each memory cell of the second set of multi-level memory cells configured to store two or more bits of data;
store the data and the parity information to the first set of single-level memory cells; and
transfer, as part of a memory management operation, the data and the parity information from the first set of single-level memory cells to the second set of multi-level memory cells.

2. The memory system of claim 1, wherein, to transfer the data and the parity information, the processing circuitry is further configured to cause the memory system to:
issue a second command from a controller of the memory system to the one or more memory devices of the memory system;
transfer the data and the parity information from the first set of single-level memory cells to one or more data latches of the one or more memory devices; and
transfer the data and the parity information from the one or more data latches to the second set of multi-level memory cells.

3. The memory system of claim 2, wherein the second command comprises a copyback command.

4. The memory system of claim 1, wherein the processing circuitry is further configured to cause the memory system to:
generate the mapping between the first set of single-level memory cells and the second set of multi-level memory cells based at least in part on determining that the second set of multi-level memory cells fails to satisfy a performance threshold.

5. The memory system of claim 1, wherein the parity information is associated with a first type of error correction and the data comprises second parity information associated with a second type of error correction different than the first type.

6. The memory system of claim 1, wherein the processing circuitry is further configured to cause the memory system to:
receive a second command to store second data to the memory system;
refrain from generating second parity information for the second data based at least in part on a second mapping between a third set of single-level memory cells and a fourth set of multi-level memory cells, each memory cell of the fourth set of multi-level memory cells configured to store two or more bits of data;
store the second data to the third set of single-level memory cells; and
transfer, as part of a second memory management operation, the second data from the third set of single-level memory cells to the fourth set of multi-level memory cells.

7. The memory system of claim 6, wherein the processing circuitry is further configured to cause the memory system to:
generate the second mapping between the third set of single-level memory cells and the fourth set of multi-level memory cells based at least in part on determining that the fourth set of multi-level memory cells satisfies a performance threshold.

8. The memory system of claim 1, wherein, to transfer the data and the parity information, the processing circuitry is further configured to cause the memory system to:
determine that at least a portion of the data comprises invalid data; and
store the invalid data to the second set of multi-level memory cells based at least in part on determining that at least the portion of the data comprises invalid data.

9. The memory system of claim 1, wherein the first set of single-level memory cells comprises a single-level cell (SLC) word line and the second set of multi-level memory cells comprises a quad-level cell (QLC) word line.

10. A non-transitory computer-readable medium storing code comprising instructions which, when executed by one or more processors of a memory system, cause the memory system to:
receive a command to store data to the memory system;
generate parity information for the data based at least in part on a mapping between a first set of single-level memory cells and a second set of multi-level memory cells, each memory cell of the second set of multi-level memory cells configured to store two or more bits of data;
store the data and the parity information to the first set of single-level memory cells; and
transfer, as part of a memory management operation, the data and the parity information from the first set of single-level memory cells to the second set of multi-level memory cells.

11. The non-transitory computer-readable medium of claim 10, wherein the instructions to transfer the data and the parity information, when executed by the one or more processors of the memory system, further cause the memory system to:
issue a second command from a controller of the memory system to one or more memory devices of the memory system;
transfer the data and the parity information from the first set of single-level memory cells to one or more data latches of the one or more memory devices; and
transfer the data and the parity information from the one or more data latches to the second set of multi-level memory cells.

12. The non-transitory computer-readable medium of claim 10, wherein the instructions, when executed by the one or more processors of the memory system, further cause the memory system to:
generate the mapping between the first set of single-level memory cells and the second set of multi-level memory cells based at least in part on determining that the second set of multi-level memory cells fails to satisfy a performance threshold.

13. The non-transitory computer-readable medium of claim 10, wherein the parity information is associated with a first type of error correction and the data comprises second parity information associated with a second type of error correction different than the first type.

14. The non-transitory computer-readable medium of claim 10, wherein the instructions, when executed by the one or more processors of the memory system, further cause the memory system to:
receive a second command to store second data to the memory system;
refrain from generating second parity information for the second data based at least in part on a second mapping between a third set of single-level memory cells and a fourth set of multi-level memory cells, each memory cell of the fourth set of multi-level memory cells configured to store two or more bits of data;
store the second data to the third set of single-level memory cells; and
transfer, as part of a second memory management operation, the second data from the third set of single-level memory cells to the fourth set of multi-level memory cells.

15. The non-transitory computer-readable medium of claim 14, wherein the instructions, when executed by the one or more processors of the memory system, further cause the memory system to:
generate the second mapping between the third set of single-level memory cells and the fourth set of multi-level memory cells based at least in part on determining that the fourth set of multi-level memory cells satisfies a performance threshold.

16. The non-transitory computer-readable medium of claim 10, wherein the instructions to transfer the data and the parity information, when executed by the one or more processors of the memory system, further cause the memory system to:
determine that at least a portion of the data comprises invalid data; and
store the invalid data to the second set of multi-level memory cells based at least in part on determining that at least the portion of the data comprises invalid data.

17. A method, comprising:
receiving a command to store data to a memory system;
generating parity information for the data based at least in part on a mapping between a first set of single-level memory cells and a second set of multi-level memory cells, each memory cell of the second set of multi-level memory cells configured to store two or more bits of data;
storing the data and the parity information to the first set of single-level memory cells; and
transferring, as part of a memory management operation, the data and the parity information from the first set of single-level memory cells to the second set of multi-level memory cells.

18. The method of claim 17, wherein transferring the data and the parity information comprises:
issuing a second command from a controller of the memory system to one or more memory devices of the memory system;
transferring the data and the parity information from the first set of single-level memory cells to one or more data latches of the one or more memory devices; and
transferring the data and the parity information from the one or more data latches to the second set of multi-level memory cells.

19. The method of claim 17, further comprising:
generating the mapping between the first set of single-level memory cells and the second set of multi-level memory cells based at least in part on determining that the second set of multi-level memory cells fails to satisfy a performance threshold.

20. The method of claim 17, wherein the parity information is associated with a first type of error correction and the data comprises second parity information associated with a second type of error correction different than the first type.

21. The method of claim 17, further comprising:
receiving a second command to store second data to the memory system;
refraining from generating second parity information for the second data based at least in part on a second mapping between a third set of single-level memory cells and a fourth set of multi-level memory cells, each memory cell of the fourth set of multi-level memory cells configured to store two or more bits of data;
storing the second data to the third set of single-level memory cells; and
transferring, as part of a second memory management operation, the second data from the third set of single-level memory cells to the fourth set of multi-level memory cells.

22. The method of claim 17, wherein transferring the data and the parity information comprises:
determining that at least a portion of the data comprises invalid data; and
storing the invalid data to the second set of multi-level memory cells based at least in part on determining that at least the portion of the data comprises invalid data.
